(19) United States
(12) Patent Application Publication
(10) Pub. No.: US 2013/0234057 A1
(43) Pub. Date: Sep. 12, 2013

(54) Valve For An Agricultural Spraying Machine

(71) Applicant: ALTEK GES. FUR ALLGEM. LANDTECHNIK MBH, Rottenburg-Hailfingen (DE)

(72) Inventor: Norbert Muller, Stuttgart (DE)

(21) Appl. No.: 13/870,044

(22) Filed: Apr. 25, 2013

Related U.S. Application Data
(63) Continuation of application No. PCT/EP2011/067831, filed on Oct. 12, 2011.

(30) Foreign Application Priority Data
Nov. 8, 2010 (DE) 10 2010 051 580.9

(51) Int. Cl. F16K 31/04; B05B 15/02

(52) U.S. Cl. CPC F16K 31/04; B05B 15/02
USPC 251/129.11; 239/104

(57) ABSTRACT

A valve for agricultural spraying machines. The valve is used to control a flow rate of a spray medium in accordance with a valve position. For this purpose, the valve comprises an electrically operated actuator, which can change the valve position of the valve. The valve comprises an electrical energy store, which stores electrical energy for operating the actuator. The valve further has a control and evaluation unit, which is configured to charge the electrical energy store and to control the actuator. The electrical energy store has a capacity that ensures at least two switching operations of the valve. The control and evaluation unit is configured to control the actuator to generate a periodic movement with a defined number of movement strokes and a defined amplitude for shaking free the valve by the help of the electrical energy store if the valve is soiled or gridlocked.

### CROSS REFERENCES TO RELATED APPLICATIONS

This application is a continuation of international patent application PCT/EP2011/067831, filed on Oct. 12, 2011 designating the U.S., which international patent application has been published in German language and claims priority from German patent application DE 10 2010 051 580.9, filed on Nov. 8, 2010. The entire contents of these priority applications are incorporated herein by reference.

### BACKGROUND OF THE INVENTION

The disclosure relates to a valve for an agricultural spraying machine, said valve being able to control a flow rate of a spray medium in accordance with a valve position and comprising an electrically operated actuator for setting the valve position.

In agriculture, the reliability of individual apparatus components plays a major role. During operation, for example in a field, all apparatus components are subjected to strong mechanical vibrations. The apparatus components have to be robust with respect to such mechanical vibrations in order to ensure a long service life. This is necessary since repairs either cannot be carried out at the site of operation of the agricultural machines or can only be carried out there with difficulty. In cases of serious faults, the operation therefore often has to be stopped completely for repair purposes.

For the spraying of fields with a spray medium, spraying machines are used, which have a multiplicity of spray nozzles. The respective spray medium is dispensed over the field by means of the spray nozzles. For example, the spray medium may be a pesticide or fertilizer. The spray nozzles are typically arranged on a boom of the spraying machine. This boom is very wide, and therefore the greatest possible area can be sprayed in a short period of time. As a result, a high number of spray nozzles are required simultaneously and are arranged uniformly along the boom. The spraying machine comprises both the boom and an agricultural machine. The boom is fastened directly to the agricultural machine or is located on a trailer, which is pulled by the agricultural machine.

The valves are typically operated by means of pneumatic or hydraulic controllers. These provide a high level of robustness with respect to mechanical vibrations. One disadvantage is the need for supply lines, which, compared to electrical lines, require a very large amount of installation space. In addition, a device for generating pressure and also a pressure accumulator have to be provided, which require further installation space and generate additional costs during production of the spraying machine. Furthermore, control on a pneumatic and hydraulic basis is relatively slow compared to electrical actuators, and therefore the versatility of the activation is limited compared to electrical actuators. A further disadvantage is that the spray nozzles can only be controlled in large groups, since individual activation can only be implemented in a very complex manner.

Due to the use of GPS systems in agricultural machinery, the spray nozzles can be controlled automatically. A method of this type is known for example from EP 0 761 084 A1. An on-board computer of the spraying machine detects and stores the positions of the spraying machine during operation. At the same time, the amount of spray medium and the area of ground in which it is distributed are detected. If, during operation, the boom projects again into an area of ground that has already been sprayed, the on-board computer then automatically switches off the corresponding spray nozzles. An area of ground is thus prevented from receiving too much spray medium.

An option for electrically controlling the spray nozzles on the boom provides the advantage here that said nozzles can be controlled very quickly. It is thus possible to set very quickly along the boom whether the spray medium is dispensed, and, if so, to what extent. Areas of land that have already been sprayed are thus prevented from being sprayed again in a very efficient and accurate manner when the spraying machine turns or avoids an obstacle. In addition, valves with electrical actuators can be activated individually in a very simple manner, thus resulting in a very accurate control.

A nozzle module that is fastened to a boom is disclosed in DE 10 2004 011 737 A1. The nozzle module has a supply line, which leads to a controllable valve. The valve is connected on the output side to one or more spray nozzles. To this end, the valve can be pneumatically or electrically activated in order to convey the spray medium from a supply line to the spray nozzle, and to then spray said spray medium there.

U.S. Pat. No. 5,772,114 mentions an electrical system for activating spray nozzles. However, it is also described that the pneumatic system would be preferable since air supply lines are more robust than electrical lines.

EP 2 153 710 A2 describes a use of electrically activatable control valves in a field sprayer. These are used to control the flow rate to the spray nozzles in accordance with the speed of the agricultural machine. To this end, a few electrical control valves are used, which each control a respective sub-breadth of the boom as a whole, comprising a multiplicity of spray nozzles.

In order to achieve accurate activation of the spray nozzles, a correspondingly large number of individually activatable valves are required. The use of a large number of valves with electrical actuators leads to a very large power demand. This is particularly the case if all valves are to be activated at the same time. In the case of wide booms with a particularly large number of valves, this may lead to an overload of the on-board system in the agricultural machine.

U.S. Pat. No. 4,813,604 indicates this problem. It is proposed to initially activate only one half of the valves at the same time and to then activate the second half. However, this has the disadvantage that the valves can only be activated in accordance with the current state of control of the valves. In other words, the possibilities for activating the valves are limited and the speed of the activation is thus reduced.

A further aspect with the use of valves with electrical actuators is that the valves are to be designed typically as opening valves, that is to say the valves are automatically closed without assistance. In the event of a fault, an uncontrollable leakage of the spray medium can thus be reliably prevented.

The German utility model DE 1 813 813 U and German patent application DE 10 2004 011 737 A1 therefore propose valves that are then automatically closed by means of a compression spring when not opened by an external application of energy. However, the use of such a spring in an electrically operated valve leads to the fact that additional electrical energy has to be applied when opening the valves in order to overcome the force of the spring.

### SUMMARY OF THE INVENTION

It is therefore an object to specify a valve that ensures a robust and reliable use in the agricultural field, wherein the valve is to be controllable very quickly.

According to a first aspect, there is provided a valve for an agricultural spraying machine, said valve being configured to control a flow rate of a spray medium in accordance with a valve position, wherein the valve comprises:

an electric motor for setting the valve position; an electrical energy store, which provides electrical energy for operating the electric motor;

a control and evaluation unit, which is configured to charge the electrical energy store and to control the electric motor;

a power source for supplying the control and evaluation unit and the motor with electrical current; and a microcontroller that detects a motor current that is supplied to the electric motor;

wherein the control and evaluation unit is configured to control the electric motor to generate a periodic movement with a defined number of movement strokes and a defined amplitude if it is identified on the basis of the detected motor current that the valve is soiled or gridlocked, and

wherein the electrical energy store has a capacity that ensures at least two such movement strokes for shaking free the valve if it is soiled or gridlocked.

According to a further aspect, there is provided a valve for an agricultural spraying machine, said valve being configured to control a flow rate of a spray medium in accordance with a valve position, wherein the valve comprises:

an electrically operated actuator for setting the valve position; an electrical energy store, which provides electrical energy for operating the actuator;

a control and evaluation unit, which is configured to charge the electrical energy store and to control the actuator;

wherein the electrical energy store has a capacity that ensures at least two switching operations of the valve, and wherein the control and evaluation unit is configured to control the actuator to generate a periodic movement with a defined number of movement strokes and a defined amplitude.

According to a still further aspect, there is provided a valve for an agricultural spraying machine, said valve being configured to control a flow rate of a spray medium in accordance with a valve position, wherein the valve comprises:

an electrically operated actuator for setting the valve position; an electrical energy store, which provides electrical energy for operating the actuator;

a control and evaluation unit, which is configured to charge the electrical energy store and to control the actuator;

wherein the control and evaluation unit is configured to charge the electrical energy store over a charging period that is considerably longer than a discharging period upon an activation of the actuator.

The new valve therefore has an energy store, which provides the electrical energy, in order to actuate the actuator. Energy from the electrical energy store is thus provided immediately for the actuator as required and does not have to be drawn directly from the power supply. Peak current values in the power supply can therefore be prevented. Once the valve has been activated, the energy store is recharged from the power supply, preferably over a charging period that is considerably longer than the discharging period upon activation of the actuator. For this purpose, a much lower current can be drawn from the power supply than would be required with direct operation of the valve via the power supply. The magnitude of the necessary current consumption for each energy store for the charging process can additionally be adapted in accordance with an available charging time. The maximum possible charging time is given from the moment at which the valve has to be ready for use once again. The minimum necessary charging time is determined by the physical properties of the energy store. On the whole, the current consumption for a multiplicity of the presented valves on a boom can thus be minimized.

In a refinement, the current consumption can be set to a value less than or equal to 0.5 amps, preferably less than or equal to 0.2 amps, and more preferably to less than or equal to 0.1 amps. The on-board power supply system of the spraying machine can thus be used as a power supply, without any risk of overload. Furthermore, the use of the energy store provides the advantage that an emergency shutdown is ensured at any moment during operation of the valve.

This results in the advantages that the activation, as a whole, of the valves is very robust with respect to external influences since a readiness for operation of the individual valves irrespective of the momentary state of the power supply is provided and ensured. In addition, the valves can be switched very quickly and reliably when the energy store is charged.

The capacity of the energy store is such that the actuator can perform at least one complete switching process without an external energy feed. The energy store preferable has a capacity that ensures at least two and preferably at least three switching processes. A particularly robust operation is thus ensured, since a switching process can be repeated without recharging. This is advantageous, for example in order to shake free a soiled and stiff valve.

In a refinement, two or more energy stores are used in order to ensure the readiness for operation of the valve. As a result, the capacity of the individual energy stores may be lower compared to a single energy store, which has an advantageous effect on the installation space requirements. In addition, the redundancy ensures greater reliability.

Here, an agricultural spraying machine is understood in particular to mean an agricultural machine that has a boom with a multiplicity of spray nozzles. The boom is preferably arranged directly on the agricultural machine or is arranged on a trailer, which is pulled by the agricultural machine.

The boom preferably has a multiplicity of nozzle modules. Each nozzle module comprises a spray nozzle holder, a valve and a spray nozzle. The spray module may also have a group of spray nozzles, which are controlled jointly by the valve. Here, the spray nozzles of a common nozzle module spray a common ground area, at least in part, with the spray medium. The use of the nozzle module has the advantage of a very compact design. For a repair or maintenance, the entire nozzle module can be replaced very quickly and easily.

A multiplicity of nozzle modules and therefore of valves may be used along the boom and can be controlled individually very easily and quickly by the electrical actuator. A particularly accurate metering of the spray medium over a field is thus enabled, since not only can entire portions of spray nozzles of the boom be switched on or switched off, but the nozzle modules along the boom can be controlled with the accuracy of the spacing of the nozzle modules.

In a refinement, the energy store is an electrical capacitor.

The energy store may be designed as an electronic component in the form of a capacitor. The advantage in this case is that capacitors only require a small amount of installation space and, at the same time, provide a high storage capacity. Furthermore, capacitors are available in a wide range of embodiments for industrial purposes, which leads to a cost-effective design of the valve. In addition, capacitors are very robust with respect to environmental influences, which increases the robustness of the valve with respect to environmental influences. Furthermore, capacitors provide the advantage that they can be charged very quickly, for example compared to chemical energy stores. On the whole, a very robust, compact and cost-effective design of the valve can thus be implemented by the use of capacitors as energy stores.

In a further refinement, the valve has a switchable electrical bypass, which can connect a power supply to the actuator.

The valve may include a switchable, electrical bypass line (the bypass), which bypasses the energy store. By connecting the bypass, the actuator can be connected directly to the power supply. At the same time, the energy store is preferably isolated from the power supply. The power supply can thus operate the actuator, without simultaneously having to charge the energy store. The current consumption of the valve is thus limited to a necessary minimum. Furthermore, it is advantageous for protection of the energy store if the actuator is simultaneously disconnected from the energy store.

The bypass is connected in particular when the energy store is not sufficiently charged or has a defect. The bypass is preferably controlled by a switchable diode.

In a further refinement, the actuator is an electric motor.

The use of the electric motor has the advantage that it can place the valve in a specific position and can then hold it in this position. It is particularly advantageous that the electric motor does not require any additional current as it holds this position, as is the case for example with a solenoid valve with a return spring.

In addition, a particularly accurate activation and therefore particularly accurate metering of the dispensed volume of spray medium can be achieved as a result of the use of the electric motor. The electric motor may be designed as a stepper motor. These have the advantage that they convert control signals particularly reliably, quickly and very accurately.

In a further refinement, the electric motor drives a spindle, which has a thread. The thread of the spindle cooperates with a mating thread of the valve lifter. By rotating the spindle, the valve lifter can be moved perpendicularly to the direction of rotation. The position of the valve lifter and therefore the flow rate can thus be set very accurately by the electric motor.

In a further refinement, a control and evaluation unit is provided, which is designed to charge the electrical energy store.

The charging of the energy store is in this case controlled by the control and evaluation unit. This contains electronic components, such as ICs, which detect a charged state of the energy store and charge said energy store as required. By setting the required amount of current, the control and evaluation unit prevents the on-board power supply system from being overloaded. The charged state of the energy store is preferably monitored permanently by the control and evaluation unit, and the charging is terminated in accordance with the charged state. The control and evaluation unit thus simultaneously forms an overcharge protection.

In a still further refinement, the bypass and/or the actuator is/are also controlled by the control and evaluation unit. On the whole, a particularly more compact and modular design of the valve can thus be achieved.

In a further refinement, the valve has a valve housing, wherein the control and evaluation unit is arranged in the valve housing. To this end, the valve housing preferably has a separate installation space, in which the control and evaluation unit is arranged. For example, this may be a side flange with a cover. It is advantageous in this case if the control and evaluation unit is particularly well protected against environmental influences. In addition, the control and evaluation unit in the separate installation space can be reached particularly well for maintenance and repair purposes.

In particularly preferred refinements, the installation space is impervious to dirt and is watertight. The control and evaluation unit is thus protected particularly well against environmental influences. This leads to a further improvement of the robustness of the valve.

A further advantage is that the control and evaluation unit is located in the vicinity of the actuator. Supply and control lines from the control and evaluation unit to the actuator can thus be very short. An energy loss between the control and evaluation unit and the actuator is thereby minimized, such that power can additionally be saved. Furthermore, a susceptibility to faults, for example as a result of mechanical damage of supply lines or control lines to the actuator, is minimized due to the vicinity. On the whole, a particularly more reliable use of the valve is thus ensured.

In a further refinement, the control and evaluation unit comprises the energy store. This provides the advantage that the control and evaluation unit can be produced jointly with the energy store in one production process, such that cost-effective production is achieved. In addition, there is the additional advantage that a modular design of the valve is achieved. For example, all relevant control components can be replaced at the same time and in a simple manner by one module in the event of a repair.

In a further refinement, the control and evaluation unit is designed to determine the valve position. The valve position is preferably determined on the basis of an electrical current, which is received by the actuator. The valve is firstly initialized in the event of start-up. The initialization brings the valve lifter into a defined starting position. This can be achieved for example by complete closing or opening of the valve. A relative movement of the valve lifter can be established on the basis of the electrical current. Mechanical constraints, for example a thread pitch of the spindle, are to be taken into account in accordance with the specific embodiment of the valve. The valve position can then be determined on the basis of the starting position and the relative movement.

One advantage is that limit switches for the valve lifter can be omitted. Limit switches are typically used to monitor the end positions of the valve lifter. They are then closed by the valve lifter when said valve lifter reaches one of the end positions. Components and additional signal lines can thus be saved as a result of the determination of the valve position by means of the control and evaluation unit, which enables economical production. In addition, possible fault sources are thus overcome, and therefore a valve that is more robust is provided.

A further advantage is that, on the basis of the valve position, it is possible to ascertain the flow rate of spray medium through the valve. A flowmeter on the valve can thus be replaced. The information concerning the flow rate can thus be monitored by the control and evaluation unit or by an external operating unit. The determination of the flow rate enables an even more precise delivery of spray medium for each area of ground. In particular, it is made possible in conjunction with a GPS system to store not only the areas of ground that have already been sprayed, but also the amount of spray medium sprayed into the respective areas of ground. A homogenous delivery of spray medium can thus also be set over the boom. In addition, the flow rate can be output to the operating unit for a user of the spraying machine.

In a further refinement, the control and evaluation unit comprises a fault detector, which is designed to check the power supply of the valve. The control and evaluation unit thus monitors the power supply of the valve, for example from the on-board power supply system. A fault in the power supply can then be detected in particular when a sharp fall in current is detected within the power supply or a cable break is identified as a result of a resistance measurement.

If the fault detector detects a fault, the valve is thus closed, preferably automatically, by the control and evaluation unit. This prevents an uncontrolled leakage of the spray liquid. The closure is then also ensured by the energy store if the power supply fails completely. The valve is thus formed as an opening valve by the control and evaluation unit. In other words, the valve is automatically always closed if no power supply is provided. The valve is advantageously designed without a return spring (that is to say springlessly). Its function is then implemented by the fault detector. Power is thus saved during operation of the valve.

In a further refinement, the control and evaluation unit reopens the valve after an automatic closure if the fault detector no longer identifies the fault. A lasting impairment of the operation due to sporadically incorrectly identified faults is thus prevented.

In a further refinement, the control and evaluation unit comprises a flicker control. The actuator is then controlled by means of the flicker control if required. The flicker control controls the actuator in such a way that it performs a periodic movement with a defined number of movement strokes and a defined amplitude. Due to the periodic movement, the valve lifter can be shaken free. This preferably occurs automatically as soon as the control and evaluation unit has identified a functional fault, in particular if the valve lifter is stuck or stiff. The control and evaluation unit can identify the sticking or the stiffness of the valve lifter for example on the basis of the current consumption of the actuator. If this is unusually high, a defect of this type is to be assumed and the control and evaluation unit activates the flicker control.

With use of an electric motor as the actuator, the electric motor is thus rotated back and forth. This rotates the spindle, whereby the valve lifter is moved up and down. The flicker control thus enables the valve lifter to be shaken free. The control and evaluation unit is preferably designed to perform at least three switching cycles, that is to say six movement strokes, of the valve lifter within the scope of flicker operation.

The capacity of the energy store is therefore preferably designed such that at least the three switching cycles, that is to say six switching movements, of the actuator are ensured. It is thus ensured that even a very stiff or heavily stuck valve lifter can be shaken free. In addition, sufficient electrical energy is thus provided for the valve to then be closed again, without the need for an external power supply.

In a further refinement , the control and evaluation unit has a BUS interface. The control and evaluation unit may thus have a separate control connection in the form of a BUS interface. The power supply of the valve can therefore be isolated from a control signal guide. This has the advantage that, with use of a multiplicity of valves, supply and control lines can be saved.

In a particularly simple and cost-effective embodiment, the valve is supplied with current and also controlled via two electrical lines. For this purpose, voltage pulses can be sent through the electrical lines. The desired direction of rotation and also the duration of rotation can be determined by the control and evaluation unit on the basis of the flank directions and the pulse length of the voltage pulses. In addition, it is conceivable in the control and evaluation unit to use electronic circuits, which can be addressed with an address via the electrical lines in accordance with the principle of a series interface and can then be activated accordingly.

In a further refinement, the BUS interface is a CAN BUS interface. The use of a CAN BUS provides the advantage that the amount of electrical lines to the valves can be highly reduced. Specifically, no cable harness has to be laid from the on-board power supply system of the agricultural machine to the individual valves. The valves can be connected in parallel to a common supply line for the supply with current. At the same time, they can be activated via a common control line.

A further advantage is that the CAN BUS is capable of being woken up. Here, “capable of being woken up” means that the valve can be operated in a power-saving mode until the valve is actually operated in order to change the valve position. Power can thus be saved very effectively.

Furthermore, it is conceivable to use an ISO BUS according to ISO 11783 as a BUS interface. An ISO BUS is widespread in agricultural engineering, and the valves can therefore be integrated easily into existing systems.

The design of a system of valves can be highly simplified by the use of the BUS interface. Costs during production can thus be reduced and the reliability can thus be increased.

In a further refinement, a diagnosis arrangement is provided, which is designed to check the readiness for operation of the control and evaluation unit. The diagnosis arrangement then monitors the control and evaluation unit. This can occur by means of a permanent monitoring during operation and/or by means of an initial check during start-up of the control and evaluation unit. The readiness for operation of each valve is thus checked during start-up of the spraying machine, and reliable and robust operation is thus ensured.

Alternatively or additionally, the diagnosis arrangement checks the position, clearance and readiness for operation of the actuator. In preferred refinements, the diagnosis arrangement also checks the voltage of the power supply and the operability of the energy store. Here, it is advantageous that the readiness for operation of the entire valve is checked regularly and that fault-free operation can thus be ensured.

In a further refinement, a display unit is provided. Said display unit may be designed as an LED. The LED is activated by the control and evaluation unit and for example can indicate the readiness for operation of the valve by illumination or non-illumination. Alternatively or additionally, fault codes can also be output by flashing signals.

In an alternative or additional refinement, it is conceivable for the control and evaluation unit to output a feedback to an external display unit (such as the operating unit). The output can be made for example via the BUS interface. In particular, the valve that is currently open, closed or defective can thus be indicated to a user.

It is advantageous that faulty valves can be identified immediately. Furthermore, with use of the fault code, the user can immediately identify which fault is present. The user can thus take appropriate countermeasures with confidence.

In a still further refinement, the control and evaluation unit comprises a data memory, which stores data detected from the valve. For example, these data may be the number of switching cycles made, a current temperature of the actuator, an applied voltage across the valve, an applied current across the valve and/or a number of faults. The data store provides the possibility of a more detailed evaluation in the event of a fault, and therefore maintenance measures can be carried out easily and quickly. In addition, it is conceivable that, in the event of a fault, the content of the data memory is output to the operating unit, and therefore a diagnosis can be made directly by the user.

It goes without saying that the features mentioned above and those yet to be explained hereinafter can be used not only in the respective combination specified, but also in other combinations or in isolation, without departing from the scope of the present invention.

### BRIEF DESCRIPTION OF THE DRAWINGS

Exemplary embodiments of the invention are illustrated in the drawing and will be explained in greater detail in the following description. In the drawing:

FIG. 1 shows a rear view of a schematic illustration of a spraying machine,

FIG. 2 shows a perspective illustration of a preferred exemplary embodiment of the new valve,

FIG. 3 shows the valve from FIG. 2 with an opened side flange,

FIG. 4 shows a plan view of the valve from FIG. 2,

FIG. 5 shows a side view of the valve from FIG. 2,

FIG. 6 shows a sectional view of the valve from FIG. 2,

FIG. 7 shows an enlarged illustration of a detail of the sectional view from FIG. 6,

FIG. 8 shows a replacement circuit diagram of a preferred exemplary embodiment of a control and evaluation unit,

FIG. 9 shows a first flow diagram of a first part of a presented method,

FIG. 10 shows a second flow diagram of a second part of the presented method,

FIG. 11 shows a third flow diagram of a third part of the presented method, and

FIG. 12 shows a fourth flow diagram of a fourth part of the presented method.

### DESCRIPTION OF PREFERRED EMBODIMENTS

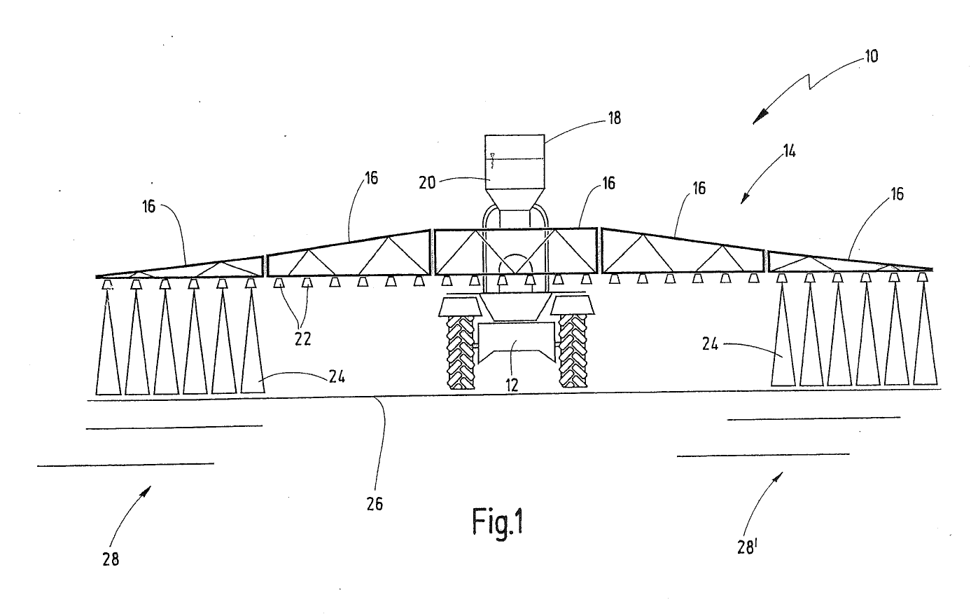

FIG. 1 shows an agricultural spraying machine, which is denoted in its entirety by the reference numeral 10. It consists of an agricultural machine 12 in the form of a tractor, to which a boom 14 is fastened. The boom 14 has five sections 16. These can be pivoted relative to one another in order to fold in the boom 14 for transport. A tank 18 is arranged on the boom and contains a spray liquid 20. Spray nozzles 22 are distributed along the entire boom 14. The spray nozzles 22 are connected to the tank 18 via tube lines so that the spray liquid 20 can be conveyed to the spray nozzles 22. The tube lines are not illustrated. The spray nozzles 22 are used to dispense the spray liquid 20 as spray jets 24 onto the ground 26. The spray nozzles 22 can be activated individually by a multiplicity of the valves according to the invention.

As is shown by way of example in FIG. 1, only the outer six spray nozzles 22 are in operation in each case. Merely areas of ground 28 and 28′ are therefore sprayed with the spray liquid 20. Due to the possibility of being able to activate each spray nozzle 22 individually, the ground 26 can be sprayed particularly exactly with the necessary amount of spray liquid 20. In particularly preferred exemplary embodiments, the agricultural machine 12 is equipped with a GPS receiver and an on-board computer. The GPS receiver and the on-board computer track the movements of the spraying machine 10 and store the areas of ground already sprayed. If the boom 14 pivots over an area of ground 28, 28′ that has already been sprayed, the on-board computer then automatically switches off the corresponding spray nozzles 22. Multiple spraying of the areas of ground 28, 28′ is thus prevented.

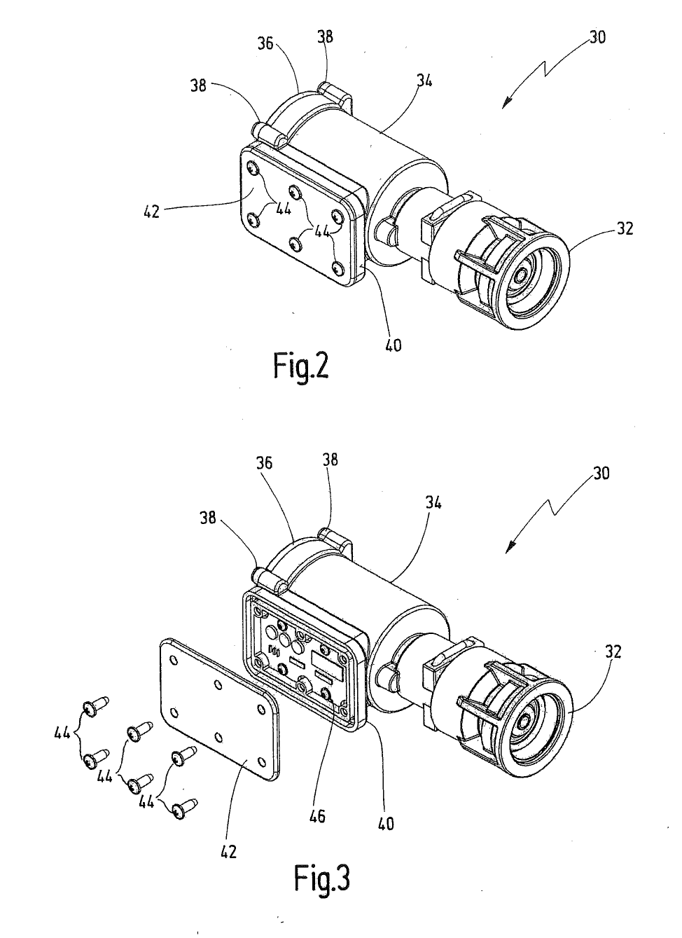

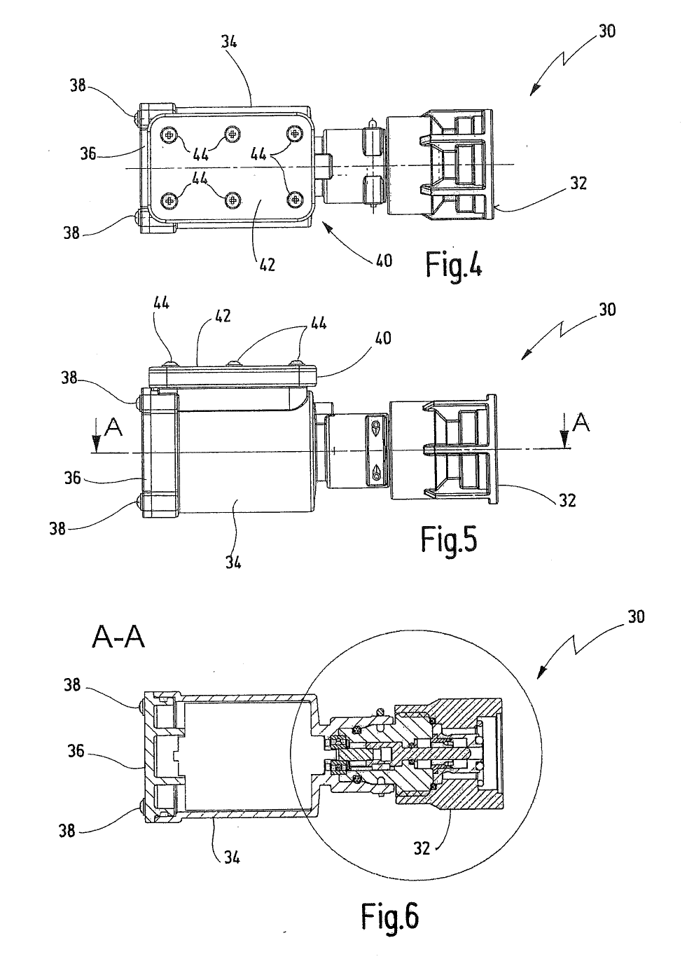

An exemplary embodiment of a valve 30 is illustrated in various views in FIGS. 1 to 7. During operation, the valve 30 is part of a nozzle module (not illustrated). The nozzle module comprises a spray nozzle holder. The spray nozzle holder has connections for a spray medium line, the spray nozzle 22 and the valve 30. The spray medium 20 is guided from the spray medium line, through the spray nozzle holder, to the valve 30. The valve 30 then controls the flow rate to the spray nozzle 22. The spray medium 20 is dispensed at the spray nozzle 22.

To connect the valve 30 to the spray nozzle holder, a coupling 32 is provided. The coupling 32 is connected to a valve housing 34, which has a cover 36. The cover 36 is fastened by four screws 38. The valve housing 34 encapsulates a motor arranged therein and protects said motor against environmental influences. In addition, the valve housing 34 has a side flange 40, which can be opened via a cover 42. The cover 42 is fastened by six screws 44. The side flange 40 is shown in an exploded illustration in FIG. 3. A control and evaluation unit 46 is arranged inside the side flange 40. The control and evaluation unit 46 is designed as a printed circuit board, on which a multiplicity of electronic components is arranged. In preferred exemplary embodiments, seals are assigned to the cover 36 and the cover 42 and seal the valve housing 34 so as to be largely watertight and impervious to dirt.

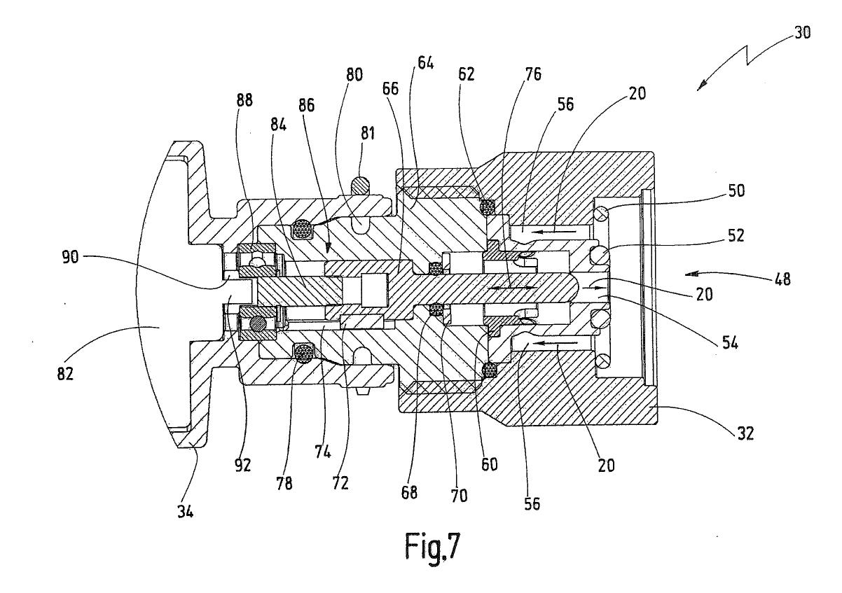

FIG. 7 shows an enlargement of the sectional illustration A-A from FIG. 6. The coupling 32 comprises an opening 48, which is connected during use of the valve 30 to the spray nozzle holder. In order to produce a liquid-tight connection, two O-rings 50 and 52 are provided, which are arranged concentrically to one another. The O-ring 52 is held by an intermediate bushing 54, which separates an inlet region 56 from an outlet region 58. The outlet region 58 is cylindrical in this case. It is surrounded radially by the inlet region 56. The O-ring 50 seals the valve 30 to the exterior. A spacer sleeve 60 is arranged in the intermediate bushing 54. The spacer sleeve 60 is recessed laterally in part so that, within the valve 30, spray liquid 20 can reach into the outlet region 58 from the inlet region 56.

The coupling 32 is connected in a liquid-tight manner via an O-ring 62 to a guide part 64. The guide part 64 guides a valve lifter 66. The valve lifter 66 is arranged concentrically in its longitudinal extent with the inlet region 56 and the outlet region 58. A further O-ring 68 is arranged around the valve lifter 66 and prevents the spray liquid 20 from crossing into the guide part 64 along the valve lifter 66. This O-ring 68 is supported between the guide part 64 and a supporting ring 70. A guide block 72 is arranged on the valve lifter 66 and is interlockingly connected to the valve lifter 66. The guide block 72 is guided in a guide groove 74 of the guide part 64. The guide block 72 and the guide groove 74 thus define a direction of movement 76 of the valve lifter 66 along its longitudinal extent. At the same time, they prevent a rotation of the valve lifter 66 within the valve 30.

Retaining recesses 80 are provided in the guide part 64 and are designed to receive a retaining clip 81. Said clip is plugged through openings in the valve housing 34 and then engages in the retaining recesses 80. The guide part 64 is thus interlockingly connected to the valve housing 34. Secure retention is achieved by this type of connection, although the valve can nevertheless be disassembled very quickly.

The guide part 64 is connected in a liquid-tight manner via a further O-ring 78 to the valve housing 34. A motor 82 is arranged inside the valve housing 34. A spindle 84 is located between the motor 82 and the valve lifter 66. The spindle 84 has a thread on the side of the valve lifter 66. The thread of the spindle 84 meshes in a region 86 with a corresponding mating thread of the valve lifter 66. By rotating the spindle 84, the valve lifter 66 can be moved along the directions of movement 76, that is to say in the direction of its longitudinal extent. For this purpose, the spindle 84 is arranged in a stationary manner in the direction of movement 76 and is mounted rotatably by a ball bearing 88. For rotation of the spindle 84, it has a groove 90 on the side of the motor 82. A drive shaft 92 of the motor 82 engages in this groove 90. The drive shaft 92 is flattened laterally for this purpose, so that the spindle 84 can rotate by means of an interlocking connection.

The motor 82 can be operated very accurately in two directions of rotation. If the motor 82 is operated, it then rotates the spindle 84 with the drive shaft 92. Due to the thread of the spindle 84 and of the valve lifter 66, the valve lifter 66 is displaced along the direction of movement 76. The valve lifter 66 is illustrated here in a valve position that fully closes the valve 30. By actuation of the motor 82, the valve lifter 66 can be moved from the illustrated valve position only in the direction of the motor 82. The valve 30 is thus opened and the spray liquid 20 flows from the inlet region 56 into the outlet region 58. Due to the geometric embodiment of the tip of the valve lifter 66 in the outlet region 58, the valve is not limited to discrete opening or closing. The desired flow rate of spray liquid 20 is defined in accordance with the valve position of the valve lifter.

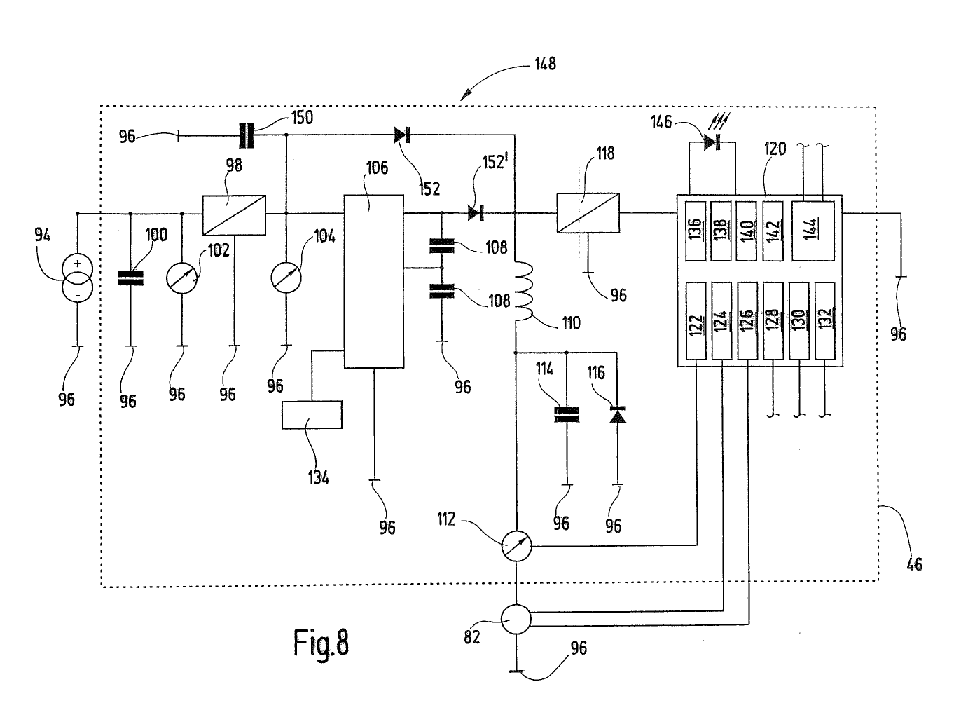

A replacement circuit diagram of the preferred exemplary embodiment of the control and evaluation unit 46 is illustrated in FIG. 8. Reference numeral 94 denotes a constant power source, which is fed from the on-board power supply system of the spraying machine. It constitutes a power supply for the valve 30. In addition, it limits a supply current for the control and evaluation unit 46 to a fixed maximum value. In particularly preferred exemplary embodiments, this maximum value is 100 mA. The positive pole of the constant power source 94 is connected to the control and evaluation unit 46 in order to supply said unit and the motor 82 with electrical current.

The control and evaluation unit 46 comprises a DC/DC converter 98, which converts the variable input voltage from the on-board power supply system to a defined constant direct voltage, which is suitable for the operation of the components of the control and evaluation unit 46. The on-board power supply system preferably supplies an electrical voltage in the range of 12 or 24 volts, which is converted in the DC/DC converter 98 to 5 volts. The DC/DC converter 98 enables the adaptation of the valve 30 to a wide operating voltage range so that the valve 30 can be operated with different electrical voltages. It also ensures an optimal adaptation of the voltage to the motor characteristics. This leads to high efficiency and therefore to an energy saving.

A capacitor 100 and a voltmeter 102 are connected parallel to the DC/DC converter 98. The capacitor 100 is used to balance voltage fluctuations of the constant power source 94. The voltmeter 102 measures a voltage U1, which is applied to the constant power source 94. Furthermore, an output voltage U2 of the DC/DC converter 98 is measured by a further voltmeter 104.

An energy controller 106 is operated by the output power of the DC/DC converter 98. The energy controller 106 controls the charging of the energy stores 108. It is connected to ground 96 for a required operating voltage. The energy stores 108 are designed in the illustrated exemplary embodiment as capacitors 108, in particular as electrochemical double-layer capacitors (“supercapacitors”). For the charging of the capacitors 108, the energy controller 106 first determines the charged state of said capacitors. It then charges the capacitors 108 when their charged state falls below a predefined minimum level. If the capacitors 108 are fully charged, the charging process is stopped, and an overcharging is thus prevented.

The stored electrical energy is conveyed as required from the capacitors 108, via a coil 110 and an ammeter 112, to the motor 82. A quenching circuit is provided parallel to the motor 82 and ammeter 112. Said circuit consists of a capacitor 114 and a diode 116.

A further DC/DC converter 118 is additionally operated by means of the electrical energy from the capacitors 108. The DC/DC converter 118 controls the applied voltage to a value with which a microcontroller 120 can be operated. The voltage may be, for example, converted to 3 V. The microcontroller 120 is connected to ground 96 for a required operating voltage.

The microcontroller 120 is used as an input and output device of the control and evaluation unit 46. It is also used as a control and regulation device for the motor 82. In order to monitor the motor 82, an interface 122 is provided. A motor current I determined by the ammeter 112 is detected via the interface 122. The control and evaluation unit 46 determines the valve position on the basis of the electrical motor current I, which is received by the motor 82. An angle of rotation of the motor 82 is established in accordance with the motor current I and known motor characteristics. The angle of rotation is then converted together with the pitch of the thread for the movement of the valve lifter 66 into a relative axial displacement of the valve lifter 66. This axial displacement then describes the change from the original position of the valve lifter 66 into the new position of the valve lifter 66. The absolute valve position can then be determined on the basis of the relative axial displacement in conjunction with the starting position.

Furthermore, it is monitored on the basis of the motor current I whether the motor 82 is loaded beyond the magnitude to be expected. In this case, the control and evaluation unit 46 draws conclusions as to whether an end position of the valve lifter 66 is reached or whether the valve lifter 66 is stuck or stiff.

Furthermore, a temperature of the motor 82 is measured via an interface 124. The control and evaluation unit 46 monitors the state of the motor 82 on the basis of the temperature in order to additionally prevent the overload of the motor 82.

Control signals are sent from the control and evaluation unit 46 to the motor 82 via an interface 126. The control signals are provided in the form of a voltage, of which the polarity defines the direction of rotation. Alternatively, the control signals may also be produced in the form of a pulse-width modulation.

Furthermore, the microcontroller 120 detects the voltage U1 of the ammeter 112 via an interface 128. In addition, the voltage U2 detected by the voltmeter 104 is forwarded via an interface 130 to the microcontroller 120. The microcontroller 120 can determine fluctuations in the voltage supply and can identify faults in the power supply of the constant power source 94 on the basis of the voltages U1 and U2.

The microcontroller 120 controls the energy controller 106 at a signal input 134 via a further interface 132. In addition, the energy reserves present in the energy stores 108 may also detected by the microcontroller 120, and therefore a readiness for operation of the valve 30 is detected and ensured by the microcontroller 120.

The microcontroller 120 also provides a flicker control 136. The flicker control 136 generates periodic alternating movements of the motor 82 so that it shakes free the valve lifter 66. Specifically, a quick succession of movements back and forth is generated so that locks or frictional resistances can be overcome. The flicker control 136 is then used by the microcontroller 120 if it is identified on the basis of the detected motor current I that the valve is heavily soiled or gridlocked.

In addition, the microcontroller 120 comprises a diagnosis arrangement 138. When the operation of the valve 30 is started, the diagnosis arrangement 138 checks whether the electrical components of the valve 30 are ready for operation. Preferably, the readiness for operation in particular of the motor 82, the constant power source 94, the energy controller 106 and the microcontroller 120 is checked.

Furthermore, the microcontroller 120 comprises a data store 140, in which data concerning the operation of the valve 46 are stored. These data are stored for diagnosis and maintenance purposes. They contain information regarding the performed switching cycles of the valve 30, the temperature of the motor 82, the applied voltage and the applied voltage across the valve 30 and also a number of faults present.

In addition, the microcontroller 120 has a fault detector 142. The fault detector 142 monitors the power supply of the valve 30. In the event of a fault, for example with a sharp fall in current as a result of a cable break, the fault detector 142 activates the motor 82 via the interface 126. The motor 82 is activated here in such a way that it brings the valve lifter 66 into a closed position. The valve 30 is thus designed in terms of control as an opening valve. In other words, the valve 30 is designed such that, in the event of a fault or in the case of faulty actuation, it is automatically closed. Due to the fault detector 142, a closing spring is replaced compared to conventional valves. The omission of the closing spring means that much less electrical energy is required to open the valve 30 compared to conventional valves.

The energy stores 108 are designed in terms of their capacity such that the flicker control 136 and the fault detector 142 can be used at any time. Said energy stores provide enough electrical energy such that at least three switching cycles can be carried out. With a sudden drop in current, it is thus ensured that the valve lifter 66 can be shaken free and that the valve 30 can be reliably closed. Operation that is more reliable and more robust is thus ensured.

Furthermore, the microcontroller 120 comprises a BUS interface 144, which serves as an input and output unit for the control and evaluation unit 46. In preferred exemplary embodiments, an external operating unit communicates bidirectionally via the BUS interface 144 with the valve 30. Different operating modes in the microcontroller 120 can be set very easily from the operating unit via the BUS interface 144. For example, a user is able to choose manually between a normal operating mode or the flicker operating mode. In addition, a feedback is implemented from the control and evaluation unit 46 to the operating unit for an output to the user. The feedback contains information regarding the readiness for operation, the operating state and faults of the valve. For example, it may also contain the data from the data memory. Furthermore, the transmission of information concerning the valve position or the flow rate of spray medium 20 in the valve 30 is conceivable.

The BUS interface 144 is designed as a CAN BUS interface. It has the advantage that only a few control lines have to be used for all valves 30 of the spraying machine 10. In addition, the CAN BUS is capable of being woken up. Here, “capable of being woken up” means that the valve 30 can be operated in a power-saving mode until the valve 30 is actually operated in order to change the valve position. In alternative exemplary embodiments, an ISO BUS or a series interface can also be used as a BUS interface 144.

By means of the BUS interface 144, the use of the microcontroller 120 enables a reliable and robust control of the valve 30 with simultaneous saving of electrical lines.

In addition, the control and evaluation unit 46 comprises a display unit in the form of an LED 146. The LED 146 is attached to the valve 30 so as to be visible from the outside. It is used to indicate the readiness for operation of the valve 30. In addition, a flashing code is emitted when a fault is identified by the fault detector 136 or the diagnosis arrangement 138. A user can thus identify immediately which valve 30 is defective at the boom 14. At the same time, he can immediately identify which defect is present specifically.

Furthermore, a bypass 148 is provided within the control and evaluation unit 46 in this preferred exemplary embodiment. The bypass 148 bypasses the energy store 108. It can supply both the microcontroller 120 and the motor 82 directly with electrical energy from the DC/DC converter 98. The bypass 148 comprises a capacitor 150, which forms a DC decoupling from the on-board power supply system. Within the bypass 148, two switchable diodes 152 and 152′ are provided, which can be controlled by the microcontroller 120. As soon as the microcontroller 120 identifies a fault of the energy stores 108, the diodes 152 and 152′ are switched accordingly. The diode 152 then releases the bypass line around the energy store 108 in order to supply current to the motor 82 and the microcontroller. By contrast, the diode 152′ blocks the energy feed from the bypass line to the capacitors 108 so that the total electrical energy is available for the motor 82. In addition, the diode 152′ protects the energy controller 106 against the energy feed from the bypass line. In preferred embodiments, the energy controller 106 is designed as a charging IC. This is protected by the diode 152′, since a voltage with incorrect polarization would otherwise be applied when the bypass 148 is open. This could lead to a defect within the charging IC. The diode 152′ can also be designed as a “normal” diode, which allows the current flow in one direction and blocks it in the other direction.

Alternatively, it is conceivable for the diode 152 to be a pin diode. The pin diode can be connected by means of a relatively strong energy pulse, and therefore no additional control line is required.

In a further alternative, it is conceivable for the energy controller 106 to switch the switchable diodes 150 and/or 152′. This has the advantage that the energy controller 106 is not fed by the energy supply from the bypass 148. A particularly reliable connection of the bypass 148 is thus ensured when there is a defect of the energy store 108.

The bypass 148 is then also used when it is identified that the energy stores 108 are insufficiently charged for a requested operation. Then, the microcontroller 120 switches the switchable diodes 152 and 152′, likewise in the above-described manner.

The bypass 148 thus ensures a direct access to the valve 30, even when there is a fault at the energy stores 108. A defective valve 30 can thus initially continue to be used, and the operation of the spraying machine 10 does not have to be interrupted due to a defective valve 30.

Furthermore, the switchable diodes 152 and 152′ are then switched back when the energy supply is stored again by the energy stores 108. This means that the bypass 148 is then closed again when the energy stores 108 are charged again and are ready for operation.

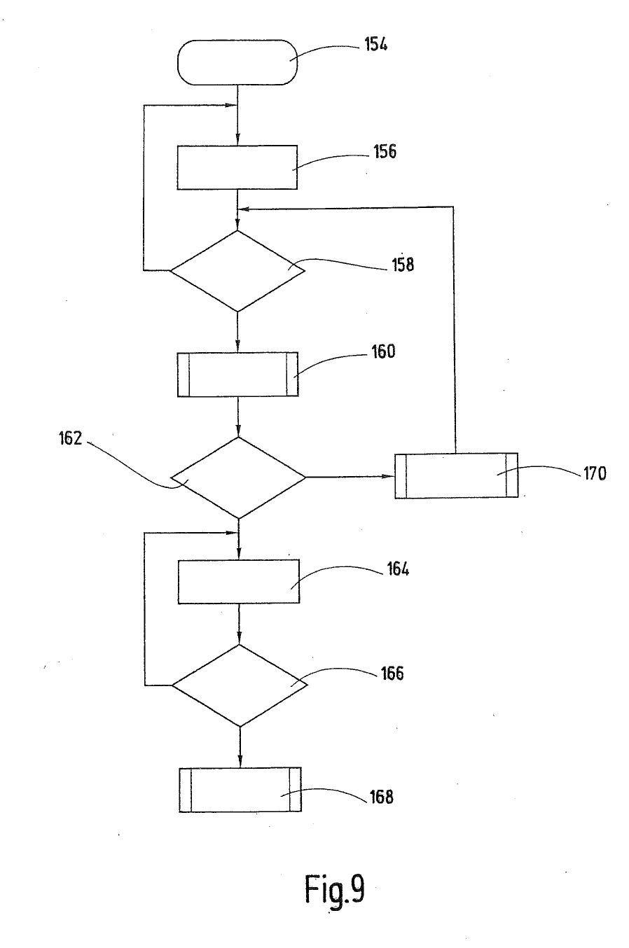

A number of flow diagrams are illustrated in FIGS. 9 to 12 and, on the whole, describe a first exemplary embodiment of the presented method.

FIG. 9 describes a starting procedure in the event of start-up of the valve 30. In a step 154, the operating voltage is applied to the valve 30. A step 156 follows, in which the energy stores 108 are precharged in order to ensure stable operation of the control and evaluation unit 46. The stores are precharged until it is identified in a step 158 that the input voltage at the control and evaluation unit 46 is greater than a minimum operating voltage. In a particularly preferred exemplary embodiment, the control and evaluation unit 46 is operated with an on-board power supply voltage of 12 volts. In this case, the stores are precharged in step 156 until a voltage that is greater than 5 volts is detected in step 158.

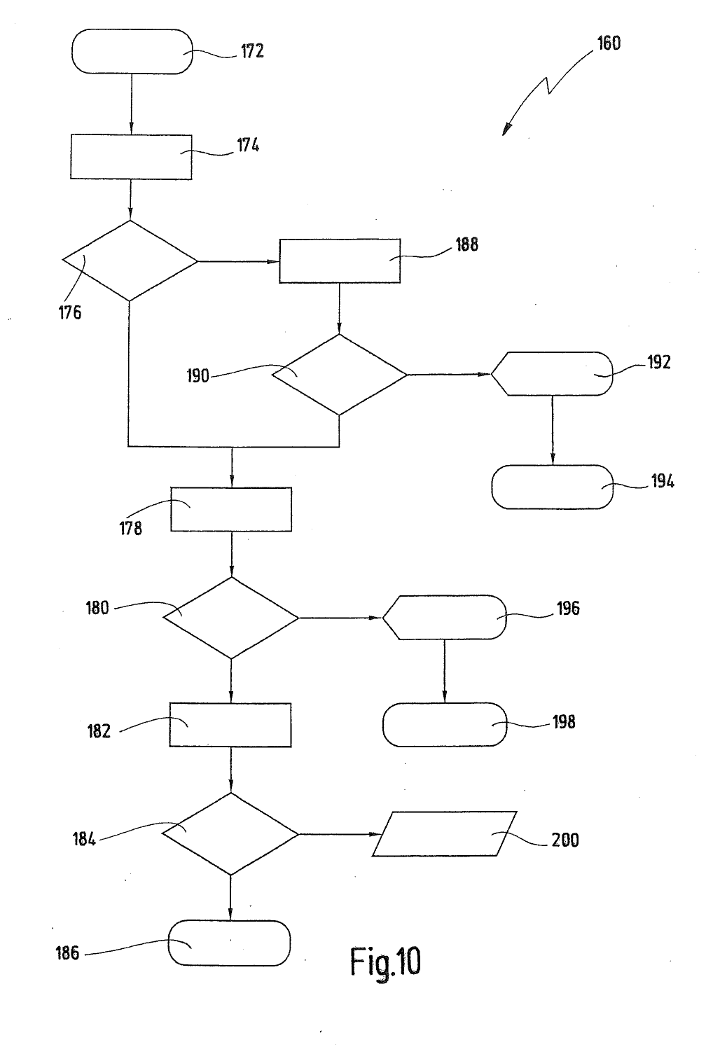

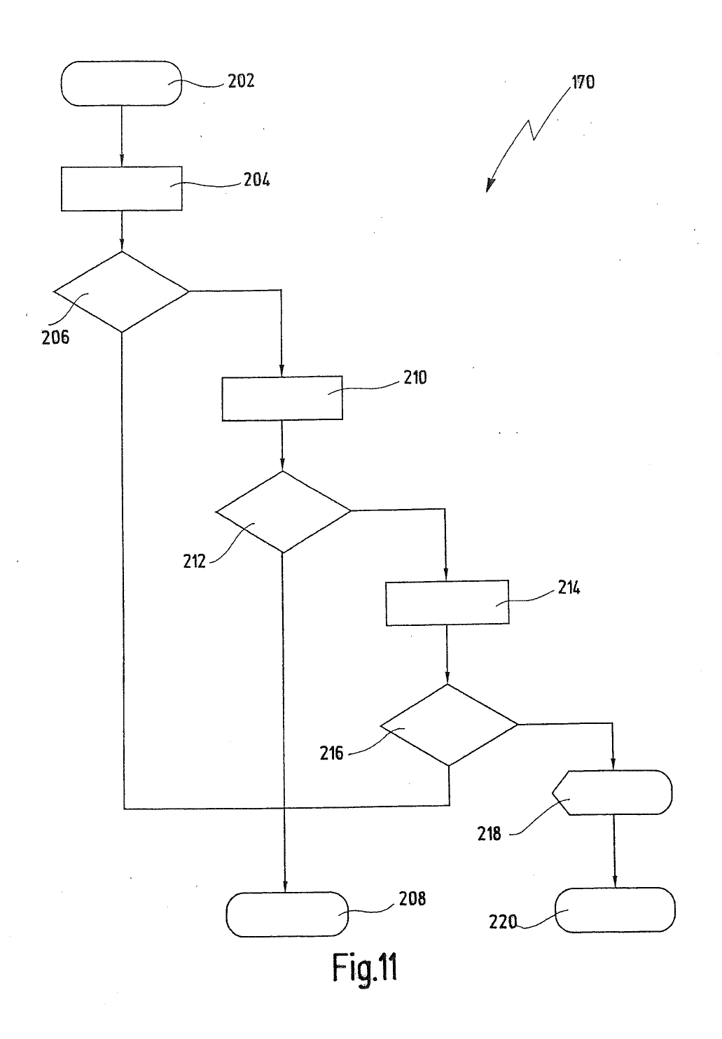

Once this has taken place, an initialization is carried out in step 160. The initialization is described in detail on the basis of FIG. 10. After successful initialization, an output of the initialization is checked for a fault signal in a step 162. If there is no fault signal, the energy stores 108 are then fully charged in a step 164.

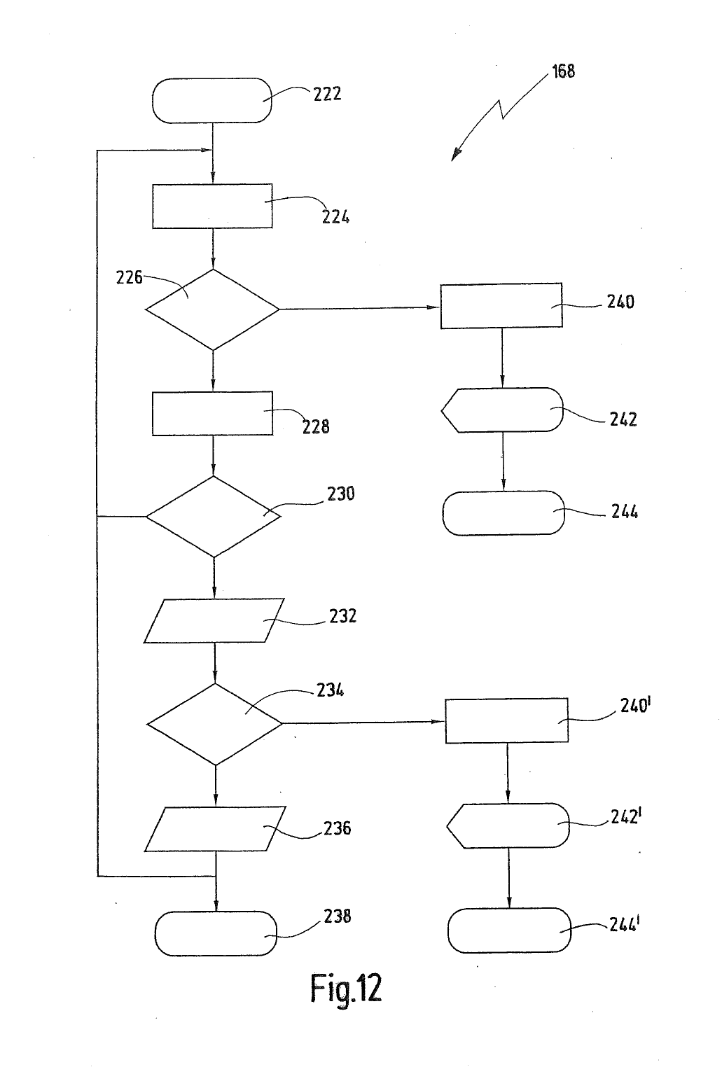

The charged state of the energy stores 108 is then checked in a further step 166. If complete charging has not yet been achieved, step 164 is then repeated until complete charging is achieved. The valve 30 then passes into an operating mode in step 168. The operating mode will be described in detail on the basis of FIG. 12.

If, in step 162, a fault signal is identified, a fault treatment is thus performed in step 170. The fault treatment is described in detail on the basis of FIG. 11. Once the fault treatment has been performed, there is a return to step 158 so that complete charging is checked once again and the system is initialized again.

FIG. 10 shows the initialization in step 160 in detail. The initialization starts in step 172, which is followed by a check of the CAN BUS in step 174. In a step 176, an output of the step 174 is evaluated. If a CAN BUS is present, it is initialized as an input and output unit in a step 178. It is then checked in step 180 whether the CAN BUS functions without fault.

If the output of step 180 is positive, there is then an end position check of the valve lifter 66 in step 182. It is thus ensured that the valve lifter 66 is moved out of a defined starting position during operation. An absolute position of the valve lifter 66 and therefore the valve position can thus be determined at any moment on the basis of the movement changes, which are detected via the current consumption of the motor 82. Furthermore, it is thus ensured that all valves 30 of the boom 14 are closed during the switch-on procedure. If, in a step 184, it is identified that the valve 30 is closed, the initialization is then terminated in a step 186 and the method from FIG. 9 is carried out.

If, in step 176, no CAN BUS is identified, a check is then carried out in a step 188 for alternative BUS systems, such as an ISO BUS or 3Wire. Step 190 evaluates an output of the check from step 188. If an alternative BUS system was identified, this is thus initialized in step 178 and is subsequently treated correspondingly to the CAN BUS. If, in step 190, no further BUS system is identified, a fault signal is thus output in a step 192 and the initialization is terminated in step 194. The method is then continued in FIG. 9, wherein the fault treatment in step 170 is performed due to the fault signal.

If, in step 180 of FIG. 10, a fault is identified during initialization from step 178, a fault signal is also output here in a step 196 and the initialization is terminated in step 198. The method is also then continued here in FIG. 9, wherein the fault treatment due to the fault signal is performed in step 170.

If it has been identified on the basis of the end position check in step 182 that the valve 30 is not closed, step 184 thus triggers a fault protocol. The fault protocol is carried out in step 200 and stores all data from the microcontroller 120. In addition, the fault is output as a flashing code via the display unit 146.

FIG. 11 shows the fault treatment from step 170 of FIG. 9 in detail. The fault treatment is started in a block 202. Faults are first read out from the data memory 140 in a step 204. The read-out data are checked in a step 206. If no data are present, the fault treatment is thus terminated in a step 208. The method is then continued in FIG. 9, wherein it is then continued in step 164 for lack of a fault notification.

If, in step 206, fault data are identified, the flicker control 136 is thus actuated in a step 210 and the valve lifter 66 is shaken free. In a step 212, it is then checked whether the process of shaking free the valve lifter was successful. If so, the fault treatment is terminated in step 208 and the method is continued in FIG. 9 in step 158.

If the process of shaking free the valve lifter was not successful, the end positions of the valve lifter 66 are adopted in a step 214. In step 216, it is then checked whether the end positions were successfully adopted. If so, the fault treatment is terminated in step 208 and the method is continued in FIG. 9 in step 158.

If the end positions were not successfully adopted, a fault signal is thus output in step 218 and the fault treatment is terminated in step 220.

FIG. 12 shows the step 168 from FIG. 9 in detail. Step 168 includes the operating mode of the valve 30. The operating mode is started in a step 222. In a step 224, the voltage of the constant power source 94 is then detected. In step 226, the value of the detected voltage is then checked. If the voltage is equal to the desired supply voltage, a transition is then made to the next step 228. Preferably, the desired voltage is the voltage of the on-board power supply system with 12 V.

In step 228, the temperature of the motor 82 is detected via the interface 124. The temperature is then evaluated in step 230. If the temperature corresponds to the desired default settings, the valve 30 can thus be opened in accordance with a control request. This occurs in a step 232. If, in step 230, it is identified that the temperature does not correspond to the requested specifications, the operating mode is restarted and continued in step 224.

A further check of the voltage of the constant power source 94 is made in step 234, when the valve 30 is to be closed. If the desired voltage is applied, the valve is thus closed in step 236.

The entire method can then be terminated in step 238.

If the check of the voltage of the constant power source 94 in step 226 indicates that the voltage is not equal to the desired voltage, an emergency shutdown is triggered in step 240. A fault signal is then output in step 242 and the operation of the valve 30 is then terminated in step 244.

The procedure is similar with an incorrect voltage in step 234. Here, an emergency shutdown is likewise triggered in the step 240′. This is followed by the output of a fault signal 242′. The operation of the valve 30 is then terminated in the step 244′.

On the whole, the operating mode is performed as a cycle, provided there is no emergency shutdown. The cycle begins after step 236 and returns the method back to step 224.

What is claimed is:

1. A valve for an agricultural spraying machine, said valve being configured to control a flow rate of a spray medium in accordance with a valve position, wherein the valve comprises:
an electric motor for setting the valve position;
an electrical energy store, which provides electrical energy for operating the electric motor;
a control and evaluation unit, which is configured to charge the electrical energy store and to control the electric motor;
a power source for supplying the control and evaluation unit and the motor with electrical current; and
a microcontroller that detects a motor current that is supplied to the electric motor;
wherein the control and evaluation unit is configured to control the electric motor to generate a periodic movement with a defined number of movement strokes and a defined amplitude if it is identified on the basis of the detected motor current that the valve is soiled or gridlocked, and
wherein the electrical energy store has a capacity that ensures at least two such movement strokes for shaking free the valve if it is soiled or gridlocked.

2. The valve as claimed in claim 1, wherein the control and evaluation unit is configured to charge the electrical energy store over a charging period that is considerably longer than a discharging period upon an activation of the electric motor.

3. The valve as claimed in claim 1, further comprising a switchable electrical bypass for connecting the power source to the electric motor and disconnecting the electrical energy store from the power source at the same time.

4. The valve as claimed in claim 1, further comprising a valve housing, in which the control and evaluation unit and the actuator are arranged.

5. The valve as claimed in claim 1, wherein the control and evaluation unit comprises the electrical energy store and the microcontroller.

6. The valve as claimed in claim 1, wherein the control and evaluation unit is configured to determine the valve position.

7. The valve as claimed in claim 1, wherein the control and evaluation unit comprises a fault detector, which is configured to check a power supply of the valve.

8. The valve as claimed in claim 1, wherein the control and evaluation unit comprises a BUS interface.

9. The valve as claimed in claim 1, further comprising a diagnosis arrangement, which is configured to check a readiness for operation of the control and evaluation unit.

10. A spray nozzle module comprising a spray nozzle, a spray nozzle holder and a valve as claimed in claim 1, wherein the valve cooperates with the spray nozzle holder and the spray nozzle.

11. A valve for an agricultural spraying machine, said valve being configured to control a flow rate of a spray medium in accordance with a valve position, wherein the valve comprises:
an electrically operated actuator for setting the valve position;
an electrical energy store, which provides electrical energy for operating the actuator;
a control and evaluation unit, which is configured to charge the electrical energy store and to control the actuator;
wherein the electrical energy store has a capacity that ensures at least two switching operations of the valve, and wherein the control and evaluation unit is configured to control the actuator to generate a periodic movement with a defined number of movement strokes and a defined amplitude.

12. The valve as claimed in claim 11, wherein the actuator is an electric motor.

13. The valve as claimed in claim 11, wherein the control and evaluation unit is configured to charge the electrical energy store over a charging period that is considerably longer than a discharging period upon an activation of the electrically operated actuator.

14. The valve as claimed in claim 12, further comprising a switchable electrical bypass for connecting a power source to the electric motor and disconnecting the electrical energy store from the power source at the same time.

15. The valve as claimed in claim 11, further comprising a valve housing, in which the control and evaluation unit and the actuator are arranged.

16. The valve as claimed in claim 11, wherein the control and evaluation unit is configured to determine the valve position.

17. The valve as claimed in claim 11, wherein the control and evaluation unit comprises a fault detector, which is configured to check a power supply of the valve.

18. The valve as claimed in claim 11, wherein the control and evaluation unit comprises a BUS interface.

19. The valve as claimed in claim 11, further comprising a diagnosis arrangement, which is configured to check a readiness for operation of the control and evaluation unit.

20. A valve for an agricultural spraying machine, said valve being configured to control a flow rate of a spray medium in accordance with a valve position, wherein the valve comprises:
an electrically operated actuator for setting the valve position;
an electrical energy store, which provides electrical energy for operating the actuator;
a control and evaluation unit, which is configured to charge the electrical energy store and to control the actuator;
wherein the control and evaluation unit is configured to charge the electrical energy store over a charging period that is considerably longer than a discharging period upon an activation of the actuator.
